(19) United States
(12) Patent Application Publication
(10) Pub. No.: US 2007/0106910 A1
(43) Pub. Date: May 10, 2007

(54) DEVICE MANAGEMENT SYSTEM, DEVICE MANAGEMENT METHOD, COMPUTER PROGRAM, AND COMPUTER READABLE STORAGE MEDIUM

(75) Inventor: Atsushi Mizuno, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/553,649

(22) Filed: Oct. 27, 2006

(30) Foreign Application Priority Data
Nov. 8, 2005 (JP) 2005-323950

(51) Int. Cl. H04L 9/32; H04L 9/00; G06F 12/14; G06K 9/00; H04K 1/00; G06F 17/30; G06F 11/30; G06F 7/04

(52) U.S. Cl. 713/189; 713/182; 726/2

(57) ABSTRACT

A print management system obtains ability information of a new printing device with reference to a device management table, when the new printing device is connected to a network. Then, the print management system obtains an encryption key (public key) of the new printing device, and registers the obtained encryption key and a network address of the new printing device into the device management table.

### BACKGROUND OF THE INVENTION

1. Field of the Invention

The present invention relates to a device management system, a device management method, a computer program, and a computer readable storage medium. More particularly, the present invention relates to a technique capable of efficiently managing cryptographic information relating to a print job.

2. Description of the Related Art

A computer network (hereinafter, simply referred to as “network”) can be preferably employed to connect a plurality of computers provided in a relatively small area, such as a floor in a building, or the entire building, or a group of buildings. Furthermore, a plurality of networks can be connected with each other to cover a relatively large area and form a global network, such as “Internet.”

Each network can include computers and various peripheral devices, such as printers, facsimiles, and copying machines. Users of the computers can operate the computer peripheral devices via the network. The network-based printing system (hereinafter, referred to as “network printing system”) enables users of computers, even the remote users, to commonly use highly advanced and speedy printers and expensive color printers to perform printing operations.

On the other hand, in view of security and cost management, each print job must be carefully and accurately managed. To this end, a conventional system issues a certificate for each print request so that the properness of the print job can be confirmed based on the certificate or the printing operation can be allowed based on the certificate.

In general, networks and Internet are opened to the public. Hence, print jobs may be falsified by third persons (or parties) when they are transferred via the network. Especially, a print job including secret data, such as client information and confidential information, must be surely protected against falsifications or unauthorized printing by third persons (parties) when it is transferred and printed via the network.

As a conventional method for protecting network print jobs against falsifications (or pretending acts), all or part or attached data of the print job can be encrypted. For example, as discussed in Japanese Patent Application Laid-open No. 2004-86894, a public key encryption system can be used, according to which a print job is encrypted beforehand using a public key and transmitted to a printer having a private key and printing of the print job is allowed only when the public key and the private key match with each other.

More specifically, according to the system proposed in Japanese Patent Application Laid-open No. 2004-86894, a print job is transmitted to a designated printer via a communication medium and only the designated printer can print the print job. To this end, the print job is encrypted using an encryption method that allows only the designated printer to decrypt the encrypted print job. Accordingly, even if an encrypted print job is stolen, the print job cannot be printed by other printers and accordingly cannot be unfaithfully used by third persons (parties).

As described above, the encryption processing for protecting the print jobs is important in the network printing system. To this end, it is generally necessary to adequately manage cryptographic information used in the encryption processing. For example, when the public key encryption system is used, a print control device including a printer driver is required to get a public key of a printing device to perform encryption relating to a print job. In this case, it is generally necessary to obtain the public key from the printing device and send the public key to the print control device.

When a total number of network devices (e.g., print control devices and printing devices) is relatively small, it may be possible to manually send the public key to each of the network devices. However, the scale of a network can be unlimitedly expanded to include a huge number of network devices or enable remote users to operate the network devices. In such a case, it is difficult to manually distribute the public key to all of network devices.

Furthermore, for management of a system, it is generally required to identify the public key of each printing device and designate a destination (i.e., print control device) to which the public key should be transmitted. However, managing the public keys is very complicated in a large-scale network including several tens to thousands network devices. Therefore, due to the complexity associated with managing public keys in a large-scale network, the system may not be appropriately maintained.

### SUMMARY OF THE INVENTION

Embodiments of the present invention are directed to a technique capable of overcoming or at least mitigating the above-described drawbacks of the related technology.

According to an aspect of the present invention, at least one exemplary embodiment is directed to a device management system configured to manage a device connected to a network, including: an identifying unit configured to identify a device newly connected to the network; a cryptographic information acquiring unit configured to obtain cryptographic information relating to a print job designating the device identified by the identifying unit; and a storage control unit configured to store, into a storage medium, device information specifying the device identified by the identifying unit and the cryptographic information obtained by the cryptographic information acquiring unit, in relation to belonging information of the device identified by the identifying unit.

According to another aspect of the present invention, at least one exemplary embodiment is directed to a method for managing a device connected to a network. The method includes: identifying a device newly connected to the network; obtaining cryptographic information relating to a print job designating the identified device; and storing, into a storage medium, device information specifying the identified device and the obtained cryptographic information, in relation to belonging information of the identified device.

According to yet another aspect of the present invention, at least one exemplary embodiment is directed to a computer program including computer-executable instructions for realizing the above-described device management method. Additionally, according to still another aspect of the present invention, at least one exemplary embodiment is directed to a computer-readable storage medium storing the above-described computer program.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating an example of a print processing system in accordance with a first exemplary embodiment.

FIG. 2 is a block diagram illustrating an example of a computer provided in a print management server in accordance with the first exemplary embodiment.

FIG. 3 is a flowchart showing an example of a management function provided by a printing device management program that the print management server can execute in accordance with the first exemplary embodiment.

FIG. 4 is a flowchart showing the rest of the management function provided by the printing device management program that the print management server can execute in accordance with the first exemplary embodiment.

FIG. 5 is a block diagram schematically illustrating a practical communication state relating to a retrieval request packet and a retrieval response packet in the print processing system in accordance with the first exemplary embodiment.

FIG. 6 is a view schematically showing an example of a device management table in accordance with the first exemplary embodiment.

FIG. 7 is a block diagram schematically illustrating a practical communication state relating to a public key certificate of a printing device transmitted to the print management server in accordance with the first exemplary embodiment.

FIG. 8 is a view schematically showing an example of a program management table in accordance with the first exemplary embodiment.

FIG. 9 is a block diagram schematically illustrating a practical communication state relating to a printer driver incorporating a public key which is transmitted and installed on a print control device in accordance with the first exemplary embodiment.

FIG. 10 is a block diagram schematically illustrating a practical communication state relating to transmission of a print job encrypted using a public key of a newly connected printing device in accordance with the first exemplary embodiment.

FIG. 11 is a block diagram illustrating an example of a print processing system in accordance with a second exemplary embodiment.

FIG. 12 is a flowchart showing an example of a management function provided by a printing device management program that the print management server can execute in accordance with the second exemplary embodiment.

FIG. 13 is a flowchart showing an example of an operation of the print control device that obtains a public key registered in a directory device in accordance with the second exemplary embodiment.

FIG. 14 is a block diagram schematically illustrating a practical communication state relating to registration of a public key and acquisition of the public key in accordance with the second exemplary embodiment.

### DETAILED DESCRIPTION OF THE EMBODIMENTS

The following description of exemplary embodiments is merely illustrative in nature and is in no way intended to limit the invention, its application, or uses.

Processes, techniques, apparatus, and systems as known by one of ordinary skill in the art may not be discussed in detail but are intended to be part of the enabling description where appropriate.

For example, certain circuitry for signal processing and other uses may not be discussed in detail. However these systems and the methods to fabricate these system as known by one of ordinary skill in the relevant art is intended to be part of the enabling disclosure herein where appropriate.

It is noted that throughout the specification, similar reference numerals and letters refer to similar items in the following figures, and thus once an item is defined in one figure, it may not be discussed for following figures.

Various exemplary embodiments, features, and aspects of the present invention will be described in detail below with reference to the drawings. It should be noted that the relative arrangement of the components, the numerical expressions and numerical values set forth in these embodiments do not limit the scope of the present invention unless it is specifically stated otherwise.

### First Exemplary Embodiment

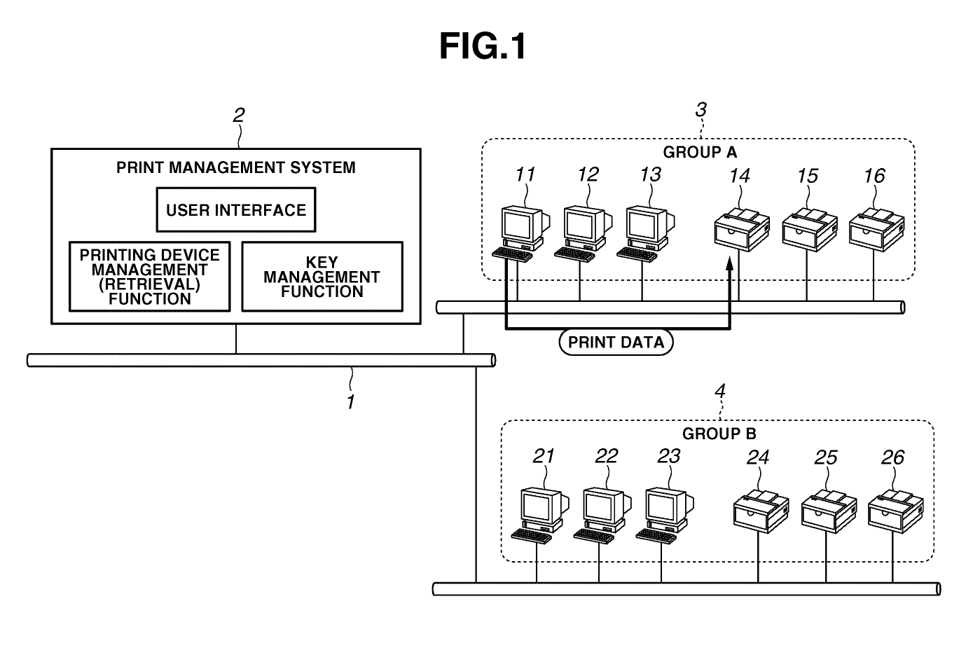

First, the first exemplary embodiment of the present invention will be described. FIG. 1 is a block diagram illustrating a print processing system in accordance with a first exemplary embodiment. In FIG. 1, a network 1 can connect later-described terminal devices. The print processing system shown in FIG. 1 can provide a networking service based on Ethernet (registration trademark) technologies for a local user group including users on the same floor, or continuous floors, of a building.

Furthermore, a wide area network (WAN) can be used to configure a network for users separated in different buildings or located at mutually remote places. The WAN is basically an assembly of two or more LANs mutually connected by high-speed digital lines, such as wide area Ethernet (registration trademark) or ISDN telephone lines. The connection of LANs is a simple electric connection realized by buses.

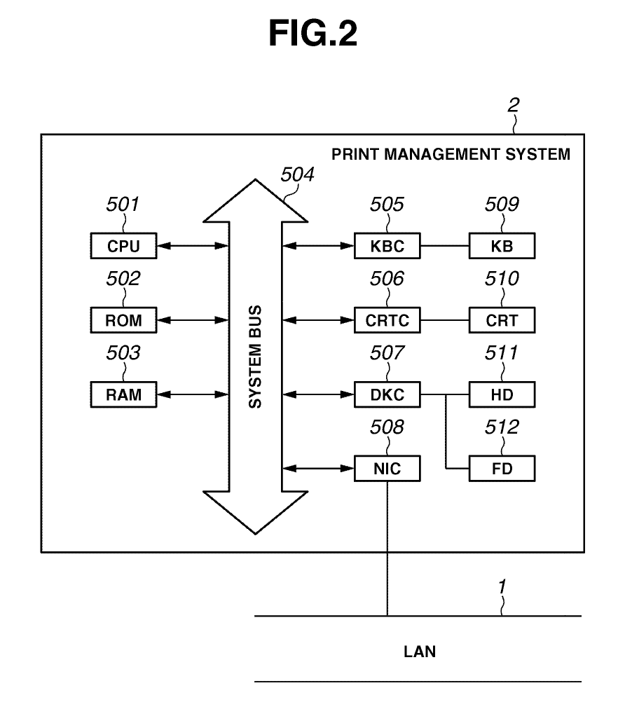

A print management system 2 can manage network devices (e.g., printing devices 14-16 and 24-26 and print control devices 11-13 and 21-23) connected to the network 1. In the print management system 2, each computer can operate under an operating system (OS) such as Microsoft Windows (registration trademark) and UNIX (registration trademark) . Furthermore, not only the OS but also application programs for managing the network devices (i.e., the printing devices 14-16 and 24-26 and the print control devices 11-13 and 21-23) can run on the computer. An example of a detailed arrangement of the computer is shown in FIG. 2.

In FIG. 1, a dotted frame 3 is a subnet group of a client (i.e., an belonging unit including a client which is logically formed in the network 1). Each terminal device connected to the network 1 is allocated a network address. An assembly of network addresses can logically form a “subnet” group. For example, according to the IP v4 protocol, the subnet mask can define what subnet each network address belongs to, so that each terminal device belonging to a subnet can be managed and controlled. The subnet group 3 includes three print control devices 11-13, three printing devices 14-16, a file server (not shown) and a database server (not shown).

A dotted frame 4 is a subnet group of another client (i.e., an belonging unit including another client which is logically formed in the network 1). The subnet group 4 is different from the subnet group 3. The subnet group 4 includes three print control devices 21-23, three printing devices 24-26, a file server (not shown) and a database server (not shown).

The print control device 11 can be configured by a computer (i.e., information processing apparatus) that can install an OS such as Microsoft Windows (registration trademark) and UNIX (registration trademark) . The print control device 11 includes a print control program (e.g., a printer driver) that can produce a print job and output the print job to the printing devices 14-16.

Furthermore, the print control device 11 can execute encryption processing relating to a print job based on cryptographic information when the print job is produced. The print job related encryption processing includes, for example, processing for encrypting a print job itself and processing for encrypting a certificate proving the correctness of the print job. The printing device can only decrypt a print job having been subjected to encryption processing corresponding to the device. As a result, any print job having been not subjected to correct encryption processing cannot be printed out.

An encryption key or information required for encrypting a print job (or a decryption key or information required for decrypting the encrypted print job) can be referred to as “cryptographic information” in the present exemplary embodiment.

The cryptographic information can be regarded as secrecy information for keeping a print job secret (or information required for canceling the secrecy of all or part or attached data of a print job). Furthermore, the cryptographic information can be regarded as falsification prohibiting information for preventing the print job from being falsified (or information required for canceling a falsification prohibited state of the print job).

As shown in FIG. 1, the print control device 11 is connected to the network 1 and belongs to the subnet group (i.e., belonging unit) 3. Other print control devices 12 and 13 are structurally similar to the print control device 11. In the present exemplary embodiment, the print control devices 11-13 can control print processing performed in the printing devices 14-16 belonging to the subnet group 3 (i.e., the same belonging unit).

In the following description, each subnet group is an example of the belonging unit. However, the belonging unit can be a division ID correlated to each client (which may be also referred to as a user ID to identify a user) . Furthermore, in a switch/hub, virtually realizing an internal division of the switch can define a virtual subnet for separating a physical connection state from a division work for a network. Thus, each network device (print control device or printing device) or each user belongs to any one of belonging units.

The printing device 14 can form an image based on a received print job and can output an image on a paper. The printing device 14 is, for example, a multifunction peripheral capable of functioning as a printer, a copying machine, or a facsimile machine. Furthermore, the printing device 14 has a function of executing encryption processing. As shown in FIG. 1, the printing device 14 belongs to the subnet group (belonging unit) 3 connected to the network 1. The printing devices 15 and 16 are identical in arrangement to the printing device 14.

The print control devices 21-23 are similar to the print control device 11 in the internal arrangement and abilities. However, as shown in FIG. 1, the print control devices 21-23 belong to the subnet group (belonging unit) 4. In FIG. 1, the print control devices 21-23 can control print processing performed in the printing devices 24-26 belonging to the subnet group 4. The printing devices 24-26 are similar to the printing device 14 in the internal arrangement and abilities. However, as shown in FIG. 1, the printing devices 24-26 belong to the subnet group (belonging unit) 4.

FIG. 2 is a block diagram illustrating an example of the computer (e.g., the print control device 11) provided in the print management system 2. In FIG. 2, the print management system 2 includes a CPU 501 that can execute a printing device management program stored in a ROM 502 or a hard disk (HD) 511, or supplied from a flexible disk drive (FD) 512. The CPU 501 can control each device connected to a system bus 504.

A RAM 503 can function as a main memory or a work area of the CPU 501. A keyboard controller (KBC) 505 can control a keyboard (KB) 509 and a pointing device (not shown) that enables a user to input instructions. A CRT controller (CRT C) 506 can control a CRT display (CRT) 510 that can display images, data and information.

A disk controller (DKC) 507 can control a hard disk (HD) 511 and a flexible disk controller (FD) 512 storing a boot program, various applications, edit files, user files, and the printing device management program. A network interface card (NIC) 508 can control bidirectional data communications performed between the print management system 2 and each printing device (14-16 and 24-26) and each print control device (11-13 and 21-23) via the network 1.

Furthermore, user interfaces of the print management system 2 according to the present exemplary embodiment include not only the devices (e.g., KB 509 and CRT 510) physically connected to the print management system 2 but also Web interfaces utilizing HTTP/HTML. Accordingly, a management computer of the network 1 can operate the print management system 2 via the network 1. In this case, the management computer can be part of the print management system 2.

Furthermore, the ROM 502 or the hard disk (HD) 511 can store, in addition to the printing device management program, a device management table 60 storing the information relating to devices to be managed, and a program management table 80 storing print control programs (i.e., printer drivers) of respective printing devices.

Next, a practical operation of the print processing system according to the present exemplary embodiment will be described below in detail. The encryption system employed in the present exemplary embodiment is a public key encryption system (i.e., public key infrastructure).

The public key encryption system uses private and public keys as cryptographic information, according to which the data encrypted using a private key can only be decrypted using a corresponding public key, or vice versa. In general, the public key is opened to the public while the private key is kept in secret.

According to this system, it is unnecessary to prepare cryptographic information (public key) for each communication partner. The public key can be arbitrarily opened to the public. Accordingly, an encryption key can be easily transmitted to a communication partner, and only an authorized user can decrypt the encrypted data.

The print processing system of the present exemplary embodiment can perform encryption processing relating to a print job based on the public key encryption system.

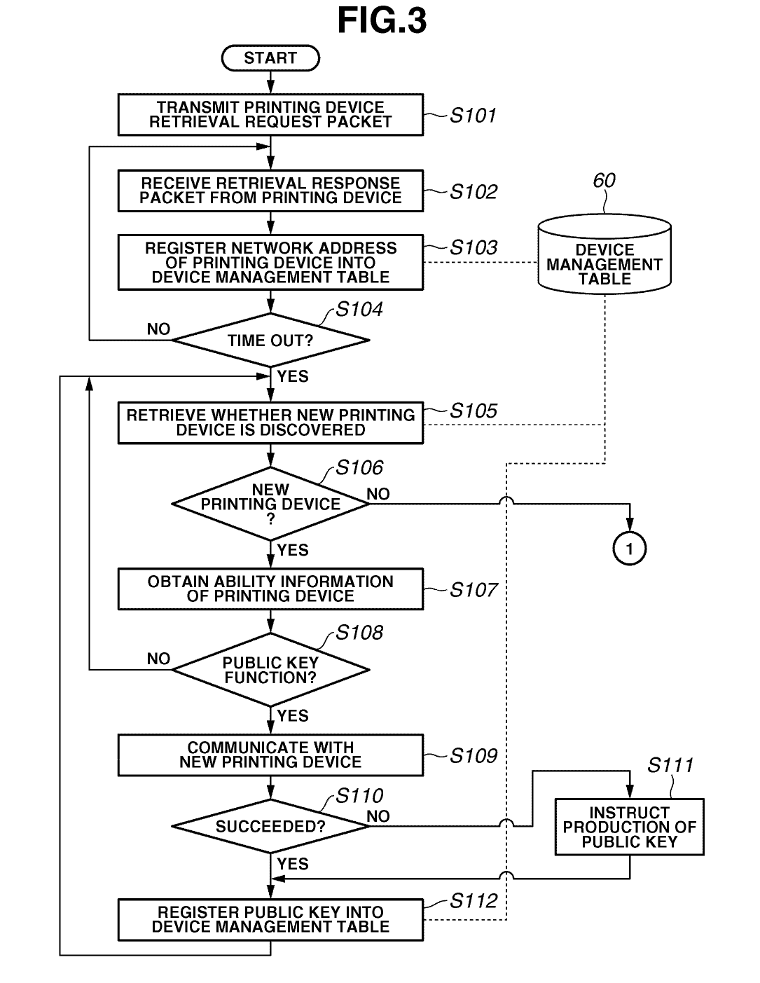

FIG. 3 is a flowchart showing an example of a management function provided by a printing device management program that the print management system 2 can execute in accordance with the first exemplary embodiment.

First, in step S101, the print management system 2 outputs a retrieval request packet to the network 1 to discriminate the printing devices 14-16 and 24-26 connected to the network 1, and starts retrieving the printing devices 14-16 and 24-26. The retrieval request packet used in the present exemplary embodiment is, for example, an SLP (Service Location Protocol) multicast packet or an SNMP (Simple Network Management Protocol) broadcast packet.

The SLP is a network protocol defined by the IETF RFC2165, which enables the print management system 2 to retrieve a service on the network 1 (i.e., a network address of a node providing the service). In the present exemplary embodiment, the print management system 2 transmits an SLP multicast packet that designates a printer as a service type, and retrieves the printers (i.e., printing devices 14-16 and 24-26) connected to the network 1 including the subnet groups 3 and 4.

Furthermore, to retrieve a network device not complying with the SLP, the print management system 2 can transmit an SNMP broadcast packet to the subnet groups 3 and 4 as described above. The SNMP is a network protocol defined by the IETF RFC1157, which enables the print management system 2 to obtain the information relating to a node on the network 1 if used together with spoofing MIB (management information base).

The print management system 2 transmits a broadcast packet of the printer MIB (IETF RFC1759) and retrieves the printers (i.e., printing devices 14-16 and 24-26) connected to the network 1 including the subnet groups 3 and 4.

Next, in step S102, the print management system 2 receives a retrieval response packet returned from the printing devices 14-16 and 24-26 in response to the retrieval request packet. The retrieval request packet is a multicast or broadcast packet, while the retrieval response packet returned from each network device has a packet format differentiated for each of the SLP and the SNMP.

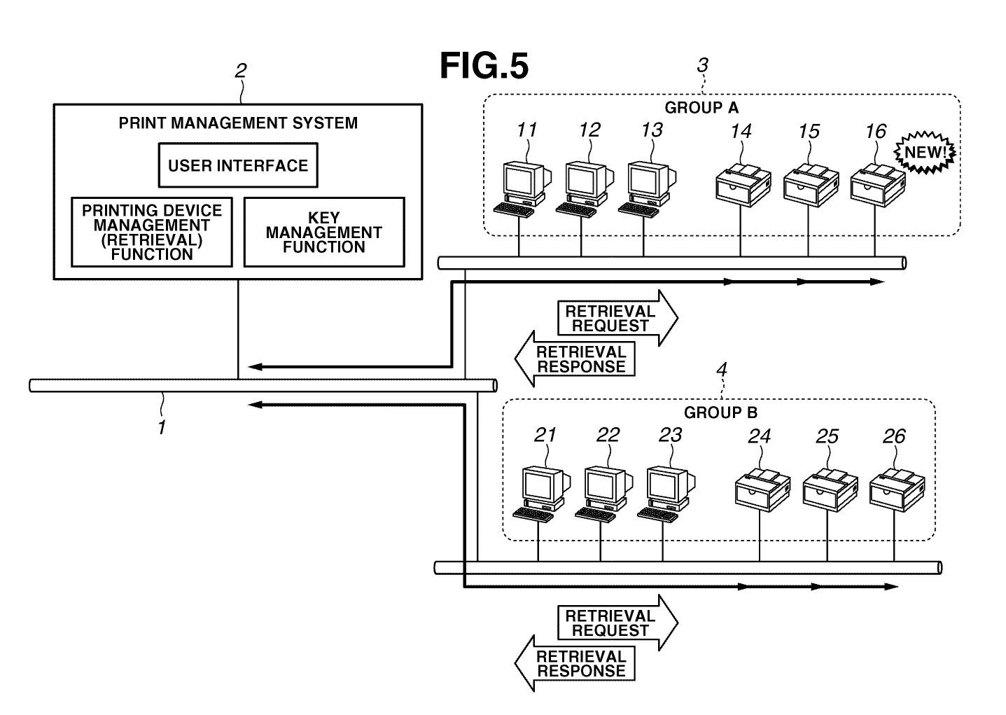

If the print management system 2 receives a retrieval response packet from any one of the network devices, the processing flow immediately proceeds to the next step S103. FIG. 5 is a block diagram schematically illustrating a practical communication state relating to a retrieval request packet and a retrieval response packet in the print processing system in accordance with the first exemplary embodiment.

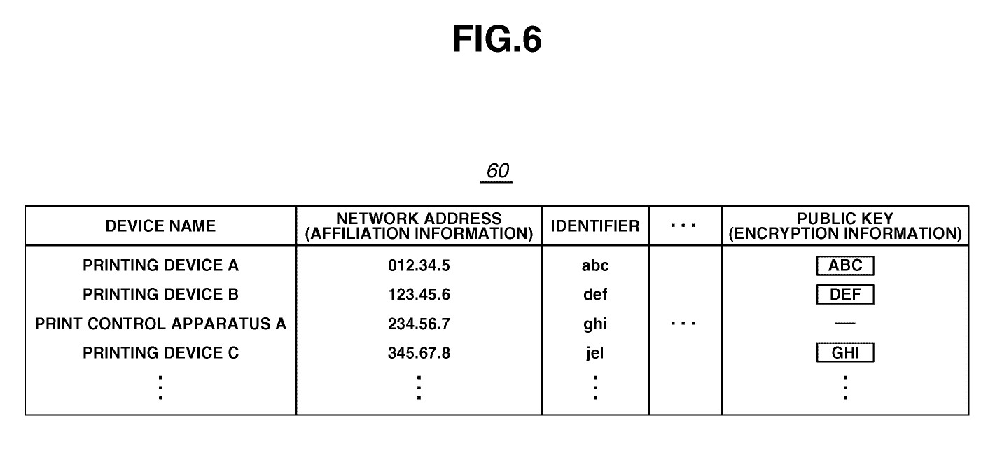

Next, in step S103, the print management system 2 extracts, from the received retrieval response packet, a network address (belonging information) of the printing device that has returned the retrieval response packet. Then, the print management system 2 registers the obtained network address into the device management table 60 shown in FIG. 6.

The belonging information extracted in this case is information that specifies the belonging unit. The device management table 60 is capable of storing printing device management programs. As shown in FIG. 6, the device management table 60 stored in the printing device management program has a configuration capable of storing printing device information including network addresses of the printing devices 14-16 and 24-26 and the print control devices 11-13 and 21-23 and the identifiers (e.g., MAC address) on the network 1.

In the present exemplary embodiment, each of the printing devices 14-16 and 24-26 has a component capable of temporarily storing a public key. The network addresses registered in the device management table 60 can be IP addresses. Furthermore, the network address can be replaced with FQDN (Fully Qualified Domain Name).

Next, in step S104, the print management system 2 determines whether a predetermined retrieval response waiting time has elapsed. An arbitrary value can be set for the retrieval response waiting time based on the settings of the printing device management programs, or according to user's designation. If the retrieval response waiting time has elapsed (i.e., YES in step S104), the processing flow proceeds to step S105. On the other hand, when the retrieval response waiting time has not yet elapsed (i.e., NO in step S104), the print management system 2 repeatedly executes the processing of steps S102 to S104.

In step S105, the print management system 2 determines whether a new printing device is discovered in the present retrieval processing, with reference to the device management table 60. To check the presence of a new printing device, the print management system 2 can determine whether new printing device identification information, such as a printing device name or a MAC address of the printing device, can be retrieved. In the present exemplary embodiment, as shown in FIG. 5, the printing device 16 is newly connected to the network 1 and the print management system 2 can discover the printing device 16 as a new printing device.

According to the present exemplary embodiment, the print management system 2 is configured to retrieve information (e.g., identification information) associated with a new printing device. However, any other method can be used to identify a new printing device. For example, the printing device newly connected to the network 1 can be configured to transmit identification information (e.g., MAC address) to the print management system 2 so that the print management system 2 can execute the processing of step S106 and succeeding steps in response to the received identification information.

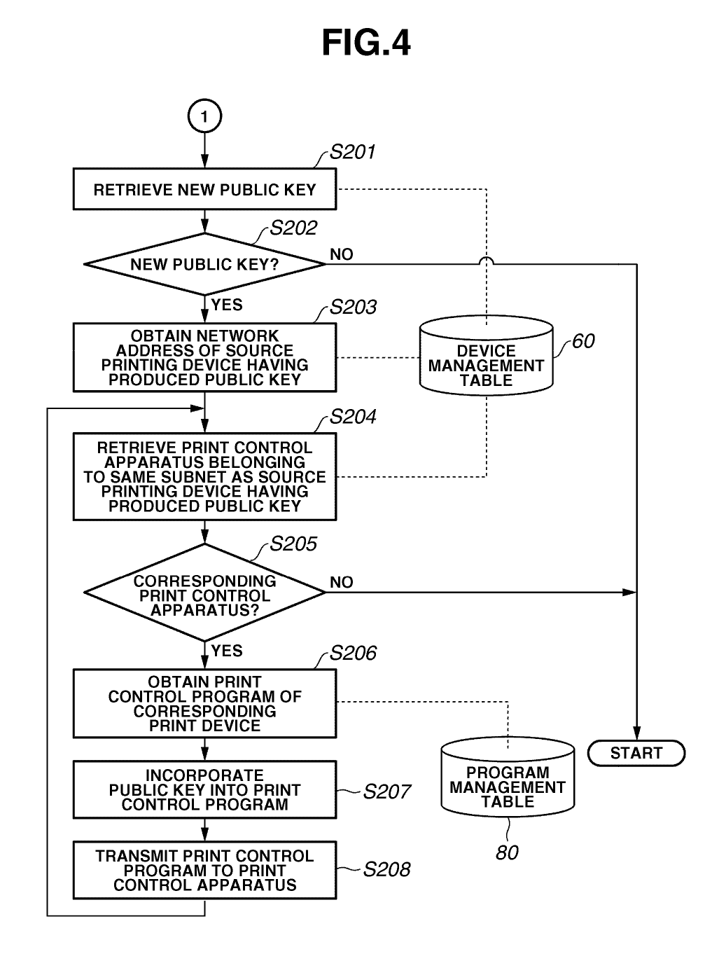

Next, in step S106, the print management system 2 determines whether a new printing device is discovered. If the new printing device retrieval processing is finished and no new printing device is present in the device management table 60 (i.e., NO in step S106), the processing flow proceeds to step S201 of FIG. 4. On the other hand, when a new printing device is present in the device management table 60 (i.e., YES in step S106), the processing flow proceeds to step S107. In the present exemplary embodiment, the print management system 2 can discover the printing device 16 as a new printing device. Therefore, the printing device 16 is subjected to the processing for a newly discovered printing device.

Next, in step S107, the print management system 2 obtains, from the new printing device (i.e., printing device 16), ability information of the printing device including encryption ability and functions of the public key encryption system. The print management system 2 can obtain the ability information by using an SLP or SNMP unicast packet.

Next, in step S108, the print management system 2 determines whether the new printing device can support the public key encryption system, based on the ability information obtained in step S107. If the new printing device can support the public key encryption system (i.e., YES in step S108), the processing flow proceeds to step S109. On the other hand, when the new printing device cannot support the public key encryption system (NO in step S108), the processing flow returns to step S105.

In step S109, the print management system 2 communicates with the new printing device (i.e., printing device 16) according to the SSL (Secure Socket Layer) which is a security protocol proposed by Netscape Communications to provide encryption, authentication, and anti-falsification functions. The version presently used is SSL3.0. TLS1.0 is presently opened to the public, as RFC2246, which is standardized by the IETF based on the SSL3.0. A version number 3.1 is used for the TLS1.0. Accordingly, the actual version of the SSL is SSL 3.1.

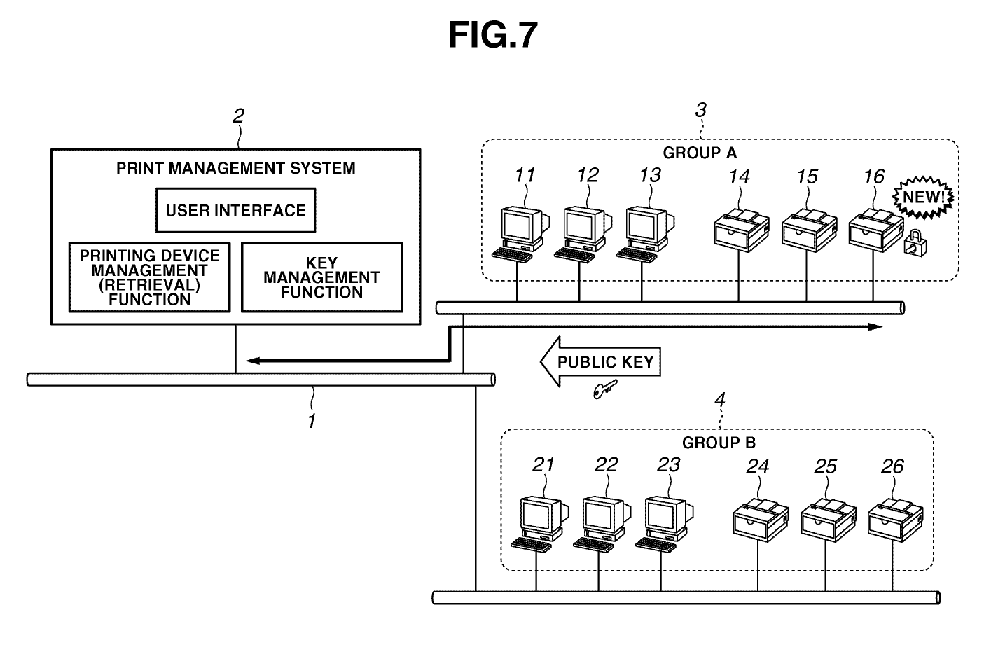

According to an SSL handshake protocol of the SSL 3.0, a server can use a certificate message to transmit a public key certificate to a client. The public key certificate according to the SSL can be defined by X.509 v3. In the present exemplary embodiment, the printing device 16 is an SSL server and the print management system 2 is a client. Hence, as shown in FIG. 7, the printing device 16 can transmit a public key certificate to the print management system 2.

Next, in step S110, the print management system 2 determines whether the SSL communication with the new printing device succeeds. If no public key is produced as cryptographic information and the SSL communication fails (i.e., NO in step S110), the processing flow proceeds to step S111 before executing step S112. On the other hand, when the SSL communication succeeds (i.e., YES in step S110), the processing flow directly proceeds to step S112 without executing step S111.

For example, the print management system 2 can obtain, from the printing device, status information indicating whether cryptographic information is produced and can determine based on the obtained status information whether the cryptographic information is not produced.

In step S111, the print management system 2 instructs the new printing device (i.e., the printing device 16) to produce a public key. The new printing device can use an SLP or SNMP unicast packet to produce a public key.

In step S112, the print management system 2 obtains a public key from the public key certificate. Then, the print management system 2 registers the obtained public key into the device management table 60 shown in FIG. 6 which can store the public key in relation to a network address (i.e., belonging information).

Through the above-described processing, the print management system 2 can accomplish the processing for obtaining a public key of a new printing device. Subsequently, the processing flow returns to step S105.

If no new printing device is present in the device management table 60 (i.e., NO in step S106), the processing flow proceeds to step S201 of FIG. 4.

In step S201, the print management system 2 retrieves new cryptographic information with reference to the device management table 60. According to the exemplary processing shown in FIG. 4, the new cryptographic information to be retrieved is a new public key.

Next, in step S202, the print management system 2 determines whether any new public key is discovered. If a new public key is discovered (i.e., YES in step S202), the processing flow proceeds to step S203. On the other hand, when no new public key is discovered (i.e., NO in step S202), the print management system 2 terminates the processing routine of the flowchart.

In step S203, the print management system 2 retrieves and obtains a network address allocated to a source printing device that has produced the public key with reference to the device management table 60. In the present exemplary embodiment, the print management system 2 can obtain a network address of the printing device 16.

Next, in step S204, the print management system 2 retrieves a print control device belonging to the subnet group (belonging unit) corresponding to the network address (i.e., the network address of the printing device 16) obtained in step S203, with reference to the device management table 60.

As described above, according to the IP v4 protocol, the subnet mask can determine what subnet each network address belongs to. The print management system 2 can retrieve a print control device belonging to the determined subnet. As shown in FIG. 6, a print control device and its network address (belonging information) are registered beforehand in the device management table 60.

Next, in step S205, the print management system 2 determines whether any corresponding print control device is present. If the corresponding print control device is present (i.e., YES in step S205), the processing flow proceeds to step S206. On the other hand, when no corresponding print control device is present, the print management system 2 terminates the processing routine of the flowchart.

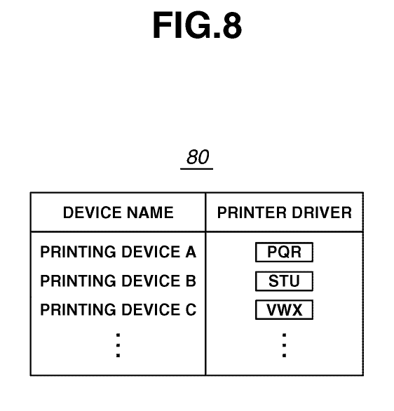

In the present exemplary embodiment, the printing device 16 belongs to the subnet group 3 and the corresponding print control device is each of the print control devices 11-13. In step S206, the print management system 2 obtains a print control program (e.g., a printer driver) of the corresponding printing device from the program management table 80 shown in FIG. 8. The printer driver of each printing device is registered beforehand in the program management table 80.

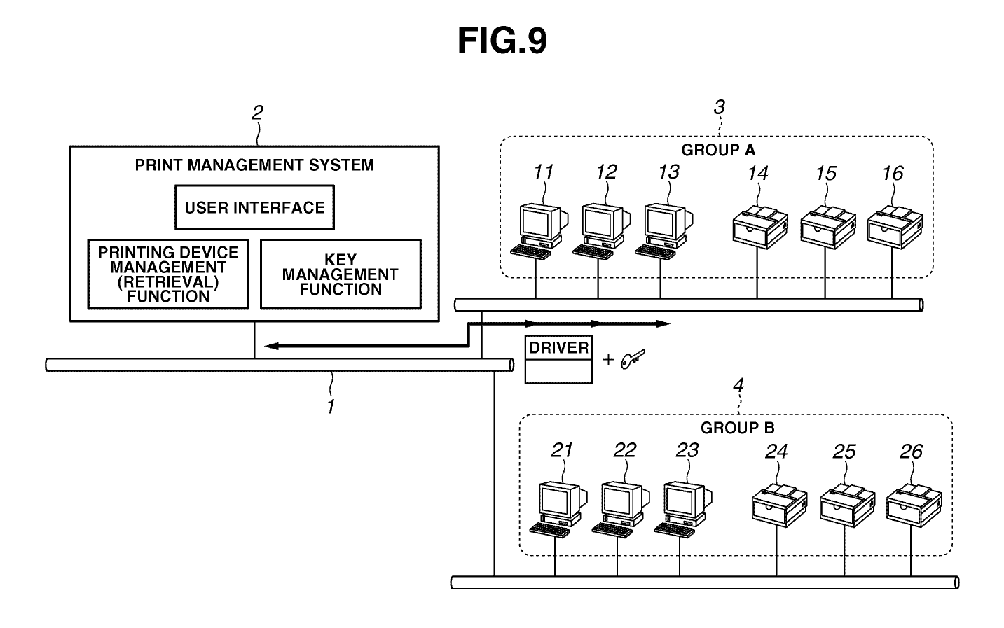

Next, in step S207, the print management system 2 incorporates a public key (i.e., cryptographic information) into the printer driver obtained in step S206. Next, in step S208, the print management system 2 transmits the printer driver incorporating the public key to the corresponding print control device so that the print control device can install the transmitted printer driver. In the present exemplary embodiment, as shown in FIG. 9, the print management system 2 transmits the printer driver incorporating the public key to each of the print control devices 11-13, so that each print control device can install the printer driver involving the cryptographic information.

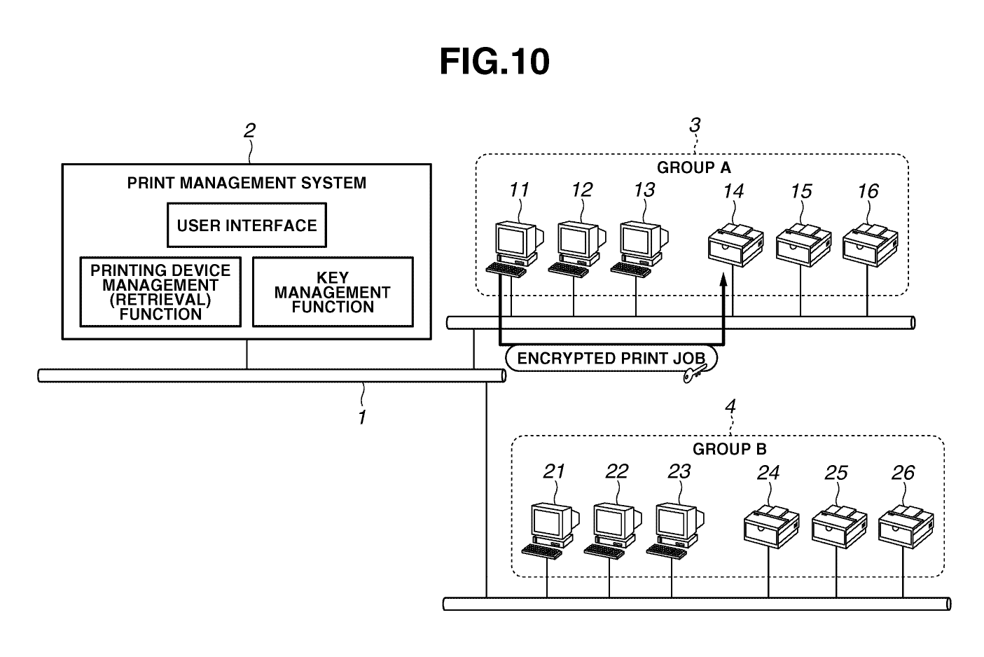

Through the processing shown in the flowchart of FIGS. 3 and 4, the print control device 11 can obtain the public key of the newly connected printing device 16 and can transmit a print job encrypted using the obtained public key to the printing device 16, as shown in FIG. 10.

As described above, according to the present exemplary embodiment, the print management system 2 can retrieve the printing devices 14-16 and 24-26 connected to the network 1 periodically or at arbitrary timing and can update the device management table 60 according to the retrieved result. Then, if the print management system 2 detects the printing device 16 newly connected to the network 1 (with reference to the device management table 60), the print management system 2 can obtain ability information of the new printing device 16.

Subsequently, based on the obtained ability information, the print management system 2 can determine whether the new printing device 16 has encryption ability. When the new printing device 16 has encryption ability, the new printing device 16 can obtain cryptographic information (public key) and register the obtained cryptographic information and a network address of the new printing device 16 into the device management table 60.

Thus, the print management system 2 can automatically collect the cryptographic information of the printing device 16 newly connected to the network 1, and can easily manage the cryptographic information. Accordingly, when numerous network devices (e.g., printing devices and print control devices) are connected to the network 1, the print management system 2 can efficiently manage and distribute the cryptographic information of each printing device. Each of the print control devices 11-13 and 21-23 can promptly obtain the cryptographic information of the printing devices 14-16 and 24-26. Thus, the encrypted printing in the network printing system can be adequately realized.

Furthermore, when the print management system 2 obtains the cryptographic information (public key) of the printing device 16 newly connected to the network 1, if the new printing device 16 includes no cryptographic information, the print management system 2 can instruct the new printing device 16 to produce cryptographic information. Therefore, the print management system 2 is not required to prepare the cryptographic information of the new printing device 16 beforehand. If no cryptographic information is present in the new printing device 16, the print management system 2 can create a pair of keys (private keys) and transmit the created private keys to the new printing device 16 that can install the received keys.

Moreover, with reference to the network address (belonging information) of the new printing device 16, the print management system 2 can specify the print control devices 11-13 that can use the new printing device 16 and can distribute a print control program involving cryptographic information to the specified print control devices.

Each of the print control devices 11-13 can easily obtain the print control program and cryptographic information of the new printing device 16. Furthermore, performing the above-described processing can enhance the security of a print job managed in the network 1.

In the present exemplary embodiment, the print management system 2 can automatically determine what subnet (belonging unit) each network device belongs to, based on the network address (belonging information) of the network device.

For example, instead of determining the subnet groups 3 and 4 according to the IP V4 protocol, a user can designate and edit the subnet groups 3 and 4 by designating a range of network addresses. In this case, if a new printing device is discovered, the print management system 2 can identify a subnet group (belonging unit) of the newly discovered printing device by determining whether the new printing device is within the range of the network addresses designated by a user.

Furthermore, in the present exemplary embodiment, the print management system 2 automatically transmits the printer driver of the printing device newly connected to the network to the print control devices 11-13 so that each print control device can install the printer driver of the newly connected printing device (refer to step S208 of FIG. 4). However, when a request is received from a print control device, the print management server can transmit a printer driver of the new printing device to the print control device. In other words, the printer driver can be a push-install type or a pull-install type.

Moreover, in addition to the printer driver, the print control device can install printer setup information such as an IP address of the new printing device. Furthermore, in the processing of step S208 of FIG. 4, it has been described that the cryptographic information used in the production of a print job by the print control device can be incorporated into the printer driver and distributed. However, the cryptographic information of the printer driver can be a plug-in type and cryptographic information other than the printer driver can be distributed to the print control device.

In this case, the print control device can receive cryptographic information from the print management system 2, and can incorporate the received cryptographic information into a printer driver installed beforehand. The above-described modified arrangements can also enhance the security of a print job managed in the network 1.

### Second Exemplary Embodiment

Next, the second exemplary embodiment of the present invention will be described. According to the above-described first exemplary embodiment, the print management system 2 is configured to transmit cryptographic information (public key) of a newly connected printing device to the print control device.

The present exemplary embodiment is characterized in that the print management system 2 can register a cryptographic information (public) key in a later-described directory device so that each print control device can obtain the registered public key.

In other words, the second exemplary embodiment is different from the above-described first exemplary embodiment in a part of the processing performed in the print processing system. Accordingly, in the following description, the portions identical or similar to those disclosed in the first exemplary embodiment are denoted by the same reference numerals shown in FIGS. 1 to 10 and will not be described below in detail.

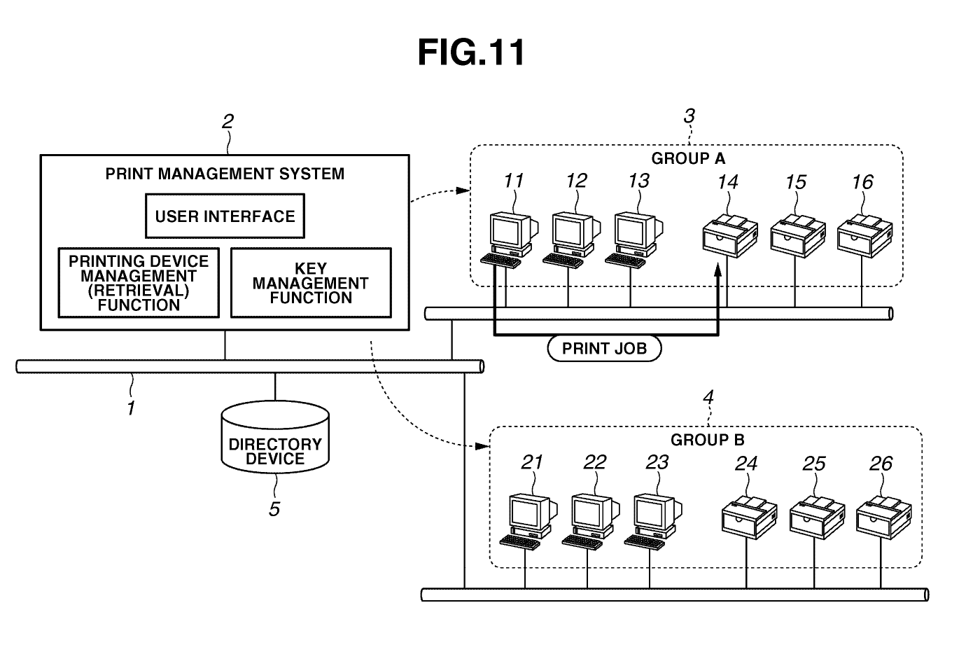

FIG. 11 is a block diagram illustrating an example of a print processing system in accordance with the second exemplary embodiment. The print processing system shown in FIG. 11 is different from the print processing system shown in FIG. 1 in that a directory device 5 is additionally provided. The directory device 5 can be added as an independent hardware device or a logical section in the print management system 2.

The directory device 5 can store configuration information (e.g., node information) of the network 1, and can register or retrieve the information to or from the node having proper authorization. The print processing system shown in FIG. 11 is similar to the print processing system shown in FIG. 1 in the rest of the arrangement. The printing device management server 2 has an internal arrangement similar to that disclosed in FIG. 2. Furthermore, the encryption system used for printing is similar to that described in the first exemplary embodiment.

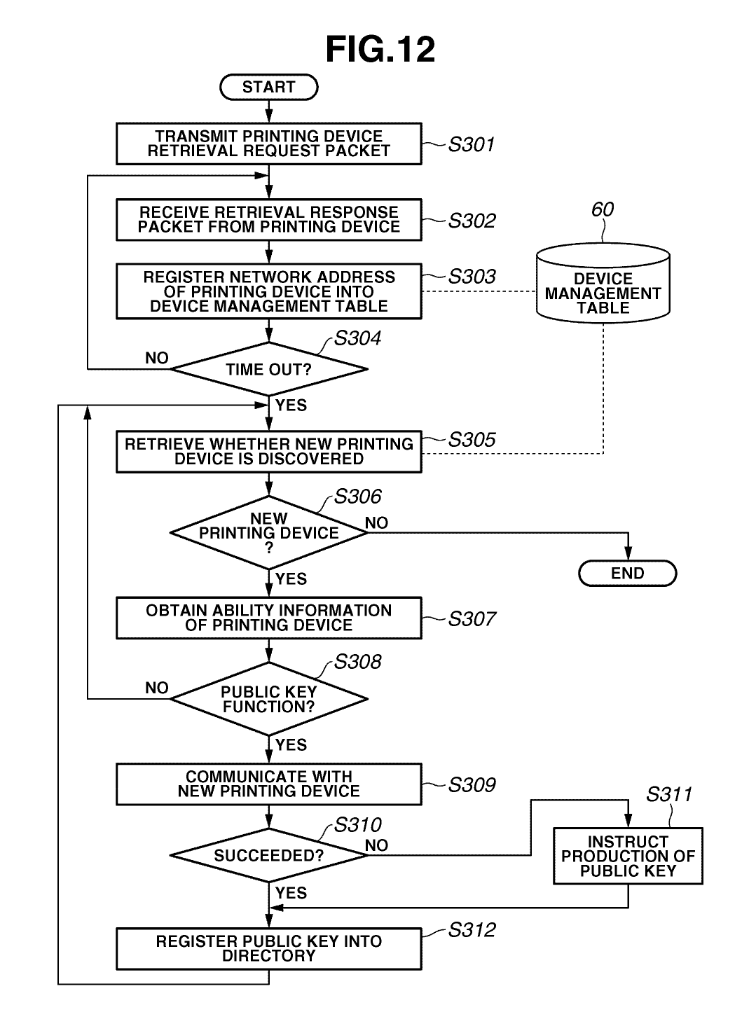

FIG. 12 is a flowchart showing an example of a management function provided by a printing device management program that the print management system 2 can execute in accordance with the second exemplary embodiment.

First, in step S301, the print management system 2 transmits a retrieval request packet, such as an SLP multicast packet or an SNMP broadcast packet, to the network 1 and starts retrieval of the printing devices 14-16 and 24-26 connected to the network 1.

As described in the first exemplary embodiment, the SLP enables the print management system 2 to retrieve a service on the network 1. In the present exemplary embodiment, the print management system 2 transmits an SLP multicast packet that designates a printer as a service type, and retrieves the printers (i.e., printing devices 14-16 and 24-26) connected to the network 1 including the subnet groups 3 and 4.

Furthermore, to retrieve a network device not complying with the SLP, the print management system 2 can transmit an SNMP broadcast packet to the subnet groups 3 and 4 as described in the first exemplary embodiment. The print management system 2 can obtain the information of a node on network 1 by using the SNMP and the MIB. The print management system 2 transmits a broadcast packet of the printer MIB (IETF RFC1759) and retrieves the printers (i.e., printing devices 14-16 and 24-26) connected to the network 1 including the subnet groups 3 and 4.

Next, in step S302, the print management system 2 receives a retrieval response packet returned from the printing devices 14-16 and 24-26 in response to the retrieval request packet. The retrieval request packet is a multicast or broadcast packet, while the retrieval response packet returned from each network device has a packet format differentiated for each of the SLP and the SNMP. If the print management system 2 receives a retrieval response packet from any one of the network devices, the processing flow immediately proceeds to the next step S303.

Next, in step S303, the print management system 2 extracts, from the received retrieval response packet, a network address (belonging information) of the printing device that has returned the retrieval response packet. Then, the print management system 2 registers the obtained network address into the device management table 60 shown in FIG. 6.

Next, in step S304, the print management system 2 determines whether a predetermined retrieval response waiting time has elapsed. An arbitrary value can be set for the retrieval response waiting time based on the settings of the printing device management programs, or according to user's designation. If the retrieval response waiting time has elapsed (i.e., YES in step S304), the processing flow proceeds to step S305. On the other hand, when the retrieval response waiting time has not yet elapsed (i.e., NO in step S304), the print management system 2 repeatedly executes the processing of steps S302 to S304.

In step S305, the print management system 2 determines whether a new printing device is discovered in the present retrieval processing, with reference to the device management table 60. In the present exemplary embodiment, as shown in FIG. 5, the printing device 16 is newly connected to the network 1 and the print management system 2 can discover the printing device 16 as a new printing device.

Next, in step S306, the print management system 2 determines whether a new printing device is discovered. If the new printing device retrieval processing is finished and no new printing device is present in the device management table 60 (i.e., NO in step S306), the print management system 2 terminates the processing routine of the flowchart. On the other hand, when a new printing device is present in the device management table 60 (i.e., YES in step S306), the processing flow proceeds to step S307. In the present exemplary embodiment, the print management system 2 can discover the printing device 16 as a new printing device. Therefore, the printing device 16 is subjected to the processing for a newly discovered printing device.

Next, in step S307, the print management system 2 obtains, from the new printing device (i.e., printing device 16), ability information of the printing device including encryption ability and functions of the public key encryption system. The print management system 2 can obtain the ability information by using an SLP or SNMP unicast packet.

Next, in step S308, the print management system 2 determines whether the new printing device can support the public key encryption system, based on the ability information obtained in step S307. If the new printing device can support the public key encryption system (i.e., YES in step S308), the processing flow proceeds to step S309. On the other hand, when the new printing device cannot support the public key encryption system (NO in step S308), the processing flow returns to step S305.

In step S309, the print management system 2 communicates with the new printing device (i.e., printing device 16) according to the SSL. In the present exemplary embodiment, the printing device 16 is an SSL server and the print management system 2 is a client. Hence, as shown in FIG. 7, the printing device 16 can transmit a public key certificate to the print management system 2.

Next, in step S310, the print management system 2 determines whether the SSL communication with the new printing device has succeeded. If no public key is produced as cryptographic information and the SSL communication is failed (i.e., NO in step S310), the processing flow proceeds to step S311 before executing step S312. On the other hand, when the SSL communication is succeeded (i.e., YES in step S310), the processing flow directly proceeds to step S312.

In step S311, the print management system 2 instructs the new printing device (i.e., the printing device 16) to produce a public key. The new printing device can use an SLP or SNMP unicast packet to produce a public key.

In step S312, the print management system 2 obtains a public key from the public key certificate. Then, the print management system 2 registers the obtained public key into the directory device 5 which can store the public key in relation to the information of the printing device.

Through the above-described processing, the print management system 2 can accomplish the processing for obtaining a public key of a new printing device. Subsequently, the processing flow returns to step S305.

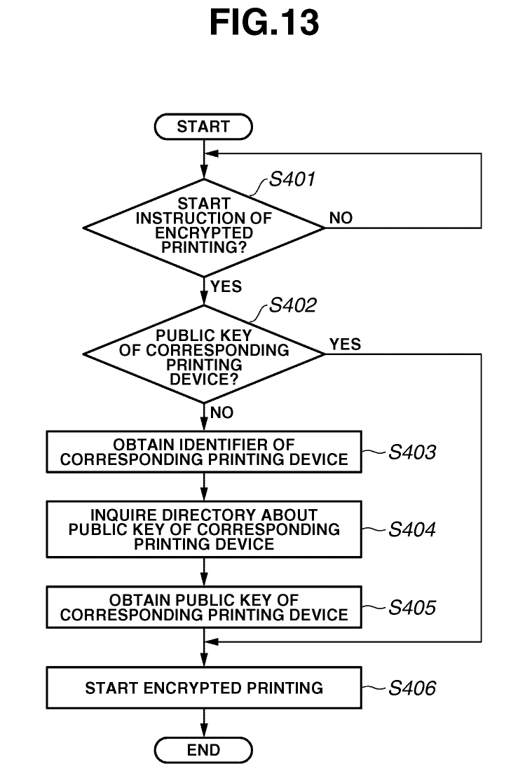

FIG. 13 is a flowchart showing an example of an operation of the print control device (11-13 and 21-23) that obtains a public key registered in the directory device 5 in accordance with the second exemplary embodiment. The print management system 2 executes the processing of the flowchart shown in FIG. 13 after accomplishing the processing of the flowchart shown in FIG. 12.

First, in step S401, the print control device determines whether a start instruction of encrypted printing designating a specific printing device is received, based on a user's operation on a user interface of the print control device. If the start instruction of encrypted printing designating a specific printing device is received (i.e., YES in step S401), the processing flow proceeds to step S402.

In step S402, it is determined whether the print control device has cryptographic information (public key) of the designated printing device. If the print control device has the cryptographic information (public key) of the designated printing device (i.e., YES in step S402), the processing flow directly proceeds to step S406 by skipping steps S403 to S405. On the other hand, when the print control device has no cryptographic information (public key) of the designated printing device (i.e., NO in step S402), the processing flow proceeds to step S403.

In step S403, the print control device obtains an identifier (e.g., printing device name, host name, network address, or MAC address) of the designated printing device on the network 1. In general, the OS of the computer can store the identifier.

Next, in step S404, the print control device inquires the directory device 5 about the cryptographic information (public key) of the designated printing device, based on the identifier obtained in step S403. The directory device 5 retrieves and obtains a public key corresponding to the printing device to which a user wants to send a print job, based on the identifier involved in the inquiry.

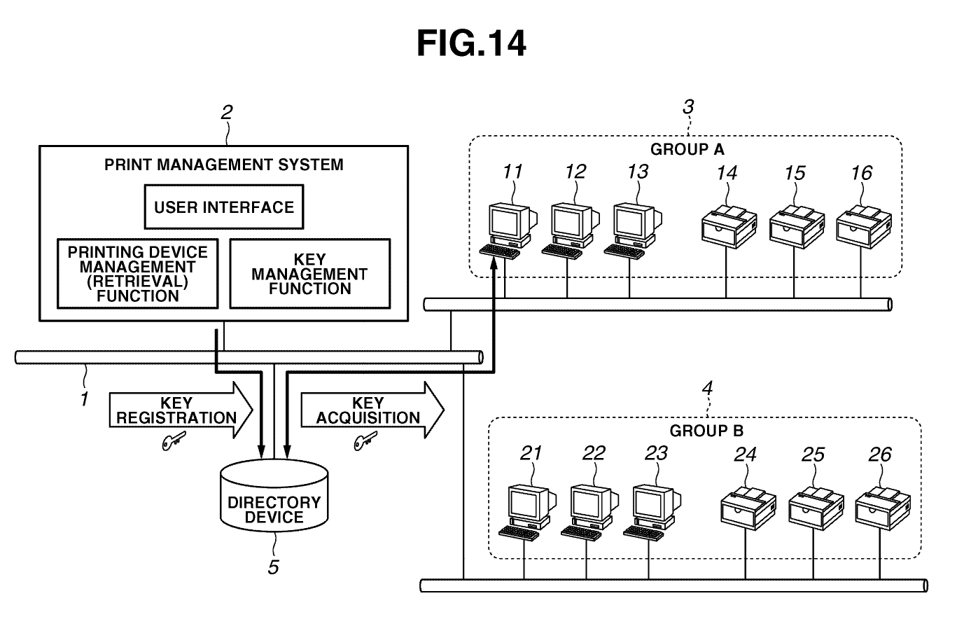

Next, in step S405, the print control device obtains the cryptographic information (public key) retrieved by the directory device 5 in step S404. FIG. 14 is a block diagram schematically illustrating a practical communication state relating to registration of a public key and acquisition of the public key in accordance with the second exemplary embodiment.

Next, in step S406, the print control device encrypts all or part or attached data of the print job using the cryptographic information (public key) obtained in step S405, and transmits the encrypted print job to the designated printing device.

As described above, according to the second exemplary embodiment, the print management system 2 can register the cryptographic information (public key) of the printing devices 14-16 and 24-26 into the directory device 5 on the network 1. Each of the print control devices 11-13 and 21-23 can obtain a registered encryption key from the directory device 5.

Thus, in addition to the effects of the above-described first exemplary embodiment, each of the print control devices 11-13 and 21-23 can obtain the encryption key at arbitrary timing using a general protocol. Thus, even when the print control devices 11-13 and 21-23 are connected to the network 1 later than the printing devices 14-16, the encryption key can be distributed to the print control devices 11-13 and 21-23.

According to the present exemplary embodiment, the print control devices 11-13 and 21-23 can request the directory device 5 to retrieve and obtain the cryptographic information (public key) . Alternatively, the print control devices 11-13 and 21-23 can request the print management system 2 to retrieve and obtain the cryptographic information (public key). The print management system 2 can return the obtained cryptographic information (public key) to a corresponding print control device.

Furthermore, the processing for retrieving a print control device and installing a print control program of the newly connected printing device 16 to the retrieved print control device can be realized by the processing similar to the steps S201 to S208 of FIG. 4. In this case, the processing of step S207 can be omitted because the directory device 5 stores the public key. Namely, it is possible to transmit and install a print control program (printer driver) involving no public key on the print control device.

### Third Exemplary Embodiment

Next, a third exemplary embodiment of the present invention will be described. According to the above-described first and second exemplary embodiments, the print management system 2 or the directory device 5 outputs the cryptographic information (public key) to a print control device and the print control device executes the encryption processing. However, any other encryption processing can be employed to efficiently manage the cryptographic information relating to a print job.

For example, in response to the inquiry from a print control device (refer to step S404), the print management system 2 or the directory device 5 can retrieve the cryptographic information (public key) of a corresponding printing device. The encryption processing relating to a print job can be performed based on the retrieved cryptographic information. In this case, the print control device is not required to install the cryptographic information (public key).

Furthermore, as part of the inquiry processing corresponding to the processing of step S404, the print control device can transmit the data to be encrypted to the print management system 2 or the directory device 5. Then, the print management system 2 or the directory device 5 can encrypt the received data and return the encrypted data to the print control device. The print control device can transmit the encrypted data, as at least part of a print job, to a printing device.

According to the above-described exemplary embodiments, the print management system 2 is a single computer (single server). However, functions of the print management system 2 can be realized by two or more computers (for example, plural servers) which are separately provided and capable of cooperatively performing the above-described processing. Furthermore, the print management system 2 can be modified to include part or all of the functions realized by the printing devices 14-16 and 24-26 and the print control devices 11-13 and 21-23.

### Other Exemplary Embodiment

Furthermore, software program code for realizing the functions of the above-described exemplary embodiments can be supplied, via a storage medium (or a recording medium), to a system or an apparatus including various devices to be actuated. A computer (or CPU or MPU) in the system or the apparatus can read the program code stored in the storage medium and can execute the readout program.

In this case, the program code read out from the storage medium can realize the functions of the exemplary embodiments. The equivalents of programs can be used if they possess comparable functions. Accordingly, when the functions or processes of the exemplary embodiments are realized by a computer, the program code installed in the computer and the recording medium storing the program are used to implement the present invention.

In other words, the present invention encompasses a computer program that can realize the functions or processes of the exemplary embodiments or any recording medium that can store the program. In this case, the type of program can be any one of object code, interpreter program, and OS script data. A recording medium supplying the program can be selected from any one of a flexible disk, a hard disk, an optical disk, a magneto-optical disk, an MO, a CD-ROM, a CD-R, a CD-RW, a magnetic tape, a nonvolatile memory card, a ROM, and a DVD (DVD-ROM, DVD-R).

In other words, the present invention encompasses a computer program that can realize the functions or processes of the exemplary embodiments or any recording medium that can store the program.

The method for supplying the program includes accessing a home page on the Internet using the browsing function of a client computer, when the home page allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different home pages. Namely, the present invention encompasses WWW servers or FTP servers that allow numerous users to download the program files so that the functions or processes of the present invention can be realized on their computers.

Furthermore, not only the functions of the above-described exemplary embodiment can be realized by a computer that executes the programs, but also an operating system (OS) running on the computer can execute part or all of the actual processing based on instructions of the programs.

Furthermore, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2005-323950 filed Nov. 8, 2005, which is hereby incorporated by reference herein in its entirety.

What is claimed is:

1. A device management system configured to manage a device connected to a network, comprising:
an identifying unit configured to identify a device newly connected to the network;
a cryptographic information acquiring unit configured to obtain cryptographic information relating to a print job designating the device identified by the identifying unit; and
a storage control unit configured to store, into a storage medium, device information specifying the device identified by the identifying unit and the cryptographic information obtained by the cryptographic information acquiring unit, in relation to belonging information of the device identified by the identifying unit.

2. The system according to claim 1, further comprising an encryption ability decision unit configured to determine whether the device newly connected to the network, which is identified by the identifying unit, has encryption ability, wherein the storage control unit stores, in the storage medium, information specifying the device having encryption ability when determined by the encryption ability decision unit, and the cryptographic information obtained by the cryptographic information acquiring unit, in relation to belonging information of the device determined as having encryption ability.

3. The system according to claim 2, further comprising a cryptographic information proprietary decision unit configured to determine whether the device determined as having encryption ability has a public key, wherein
if the cryptographic information proprietary decision unit determines that the device has the public key, the cryptographic information acquiring unit obtains the public key as the cryptographic information, and
if the cryptographic information proprietary decision unit determines that the device has no public key, the cryptographic information acquiring unit instructs the device decided as having no public key to create a public key and obtains a created public key as the cryptographic information.

4. The system according to claim 2, further comprising a cryptographic information proprietary decision unit configured to determine whether the device determined as having encryption ability has a public key, wherein
if the cryptographic information proprietary decision unit determines that the device has the public key, the cryptographic information acquiring unit obtains the public key as the cryptographic information, and
if the cryptographic information proprietary decision unit determines that the device has no public key, the cryptographic information acquiring unit produces a private key and transmits the produced private key to the device decided as having no public key.

5. The system according to claim 1, further comprising:
a print control device specifying unit configured to specify a print control device capable of controlling the device identified by the identifying unit based on the belonging information in the storage medium stored by the storage control unit, and
an output unit configured to output the cryptographic information obtained by the cryptographic information acquiring unit to the print control device specified by the print control device specifying unit.

6. The system according to claim 5, wherein the output unit outputs the cryptographic information obtained by the cryptographic information acquiring unit in response to a request received from the print control device specified by the print control device specifying unit.

7. The system according to claim 6, wherein the output unit outputs, to the print control device specified by the print control device specifying unit, cryptographic information when a print job designating the device identified by the identifying unit is produced.

8. The system according to claim 5, wherein the print control device specifying unit specifies a print control device belonging to a subnet based on a network address of the device identified by the identifying unit as a print control device corresponding to the device identified by the identifying unit.

9. The system according to claim 1, further comprising an output unit configured to output, to a directory device connected to the network, identification information of the device identified by the identifying unit and cryptographic information relating to a print job designating the device identified by the identifying unit and obtained by the cryptographic information acquiring unit.

10. The system according to claim 9, further comprising:
a print control device specifying unit configured to specify a print control device capable of controlling the device identified by the identifying unit based on the belonging information in the storage medium stored by the storage control unit; and
an additional output unit configured to output information used for controlling the device identified by the identifying unit to the print control device specified by the print control device specifying unit.

11. The system according to claim 10, wherein the print control device specifying unit determines an belonging unit based on the belonging information stored by the storage control unit, and specifies a print control device belonging to the determined belonging unit as a print control device capable of controlling the device identified by the identifying unit.

12. The system according to claim 1, wherein the belonging information contains at least one of a subnet, a virtual subnet, and a user ID.

13. A method for managing a device connected to a network, comprising:
identifying a device newly connected to the network;
obtaining cryptographic information relating to a print job designating the identified device; and
storing, into a storage medium, device information specifying the identified device and the obtained cryptographic information, in relation to belonging information of the identified device.

14. The method according to claim 13, further comprising:
determining whether the identified device newly connected to the network has encryption ability; and
storing information indicating that the identified device has encryption ability if it is determined that the identified device has encryption ability.

15. The method according to claim 14, further comprising:
determining whether the device determined as having encryption ability has a public key, wherein
if it is determined that the device has the public key, the obtaining of the cryptographic information comprises obtaining the public key as the cryptographic information, and
if it is determined that the device has no public key, the method further comprises instructing the device decided as having no public key to create a public key and obtaining a created public key as the cryptographic information.

16. The method according to claim 14, further comprising:
determining whether the device determined as having encryption ability has a public key, wherein
if it is determined that the device has the public key, the obtaining of the cryptographic information comprises obtaining the public key as the cryptographic information, and
if it is determined that the device has no public key, the method further comprises producing a private key and transmitting the produced private key to the device decided as having no public key.

17. The method according to claim 13, further comprising:
specifying a print control device capable of controlling the identified device based on the belonging information stored in the storage medium; and
outputting the obtained cryptographic information to the specified print control device.

18. The method according to claim 17, wherein the obtained cryptographic information is output in response to a request received from the specified print control device.

19. The method according to claim 18, wherein the cryptographic information is output to the specified print control device when a print job designating the identified device is produced.

20. The method according to claim 17, wherein the specifying of a print control device comprises specifying a print control device belonging to a subnet based on a network address of the identified device as a print control device corresponding to the identified device.

21. The method according to claim 13, further comprising:
outputting, to a directory device connected to the network, identification information of the identified device and the obtained cryptographic information relating to a print job designating the identified device.

22. The method according to claim 21, further comprising:
specifying a print control device capable of controlling the identified device based on the belonging information stored in the storage medium; and
outputting information used for controlling the identified device to the specified print control device.

23. The method according to claim 22, further comprising:
determining an belonging unit based on the belonging information stored in the storage medium; and
specifying a print control device belonging to the determined belonging unit as a print control device capable of controlling the identified device.

24. The method according to claim 13, wherein the belonging information contains at least one of a subnet, a virtual subnet, and a user ID.

25. A computer-readable storage medium storing instructions which, when executed by an apparatus, causes the apparatus to perform operations comprising:
identifying a device newly connected to the network;
obtaining cryptographic information relating to a print job designating the identified device; and
storing, into a storage medium, device information specifying the identified device and the obtained cryptographic information, in relation to belonging information of the identified device.
